(19) United States
(12) Patent Application Publication
(10) Pub. No.: US 2026/0131463 A1
(43) Pub. Date: May 14, 2026

(54) INFORMATION PROCESSING APPARATUS AND INFORMATION PROCESSING METHOD

(71) Applicant: SEIKO EPSON CORPORATION, Tokyo (JP)

(72) Inventor: Kazushige NISHIMORI, AZUMINO-SHI (JP)

(21) Appl. No.: 19/386,086

(22) Filed: Nov. 11, 2025

(30) Foreign Application Priority Data
Nov. 13, 2024 (JP) 2024-197999

(51) Int. Cl. B25J 9/16

(52) U.S. Cl. CPC B25J 9/1661

(57) ABSTRACT

An information processing apparatus includes: a first memory configured to store, for a certain period of time in real time, operation information when a robot is operating; a determination section configured to determine whether or not a predetermined trigger condition has occurred; and a writing section configured to extract specific operation information corresponding to a reason for occurrence of the trigger condition from the operation information stored in the first memory and write the specific operation information in a second memory in a case where the determination section determines that the trigger condition has occurred, the writing section dividing the specific operation information into a plurality of pieces of time-specific information for each predetermined unit time and writing the plurality of pieces of time-specific information one by one in the second memory.

### CROSS-REFERENCE TO RELATED APPLICATIONS

The present application is based on, and claims priority from JP Application Serial Number 2024-197999, filed November 13, 2024, the disclosure of which is hereby incorporated by reference herein in its entirety.

### BACKGROUND OF THE INVENTION

### 1. Technical Field

The present disclosure relates to an information processing apparatus and an information processing method.

### 2. Related Art

In recent years, automation of work using various robots and robot peripheral devices has been accelerated due to steep rise in labor cost and shortage of human resources in factories. In regard to such robots, it is known that a robot apparatus as described in JP-A-2020-163474 is used to store robot operation information. Accordingly, it is possible to analyze the robot operation information when an error occurs and to specify a reason, a degree, and the like of the error.

An information processing apparatus described in JP-A-2020-163474 includes a temporary data recording section configured to record operation information for a certain period of time in real time, a determination section configured to determine whether or not a trigger condition has occurred, and a trigger time data recording section configured to extract and record operation information corresponding to an error from the operation information recorded in the temporary data recording section when the trigger condition has occurred. Also, in a case where the trigger condition occurs at the n-th timing of the temporary data recording section, for example, storing up to (n + k)-th data after the timing is waited, and the data is transferred along with up to (n - m)-th data in the past to the trigger time data recording section.

Although the information processing apparatus described in JP-A-2020-163474 collectively transfers the (n - m)-th data to the (n + k)-th data to the trigger time data recording section in this manner, there is a concern that the (n - m)-th data to the (n + k)-th data cannot be saved normally in a case where a problem occurs in the course of the transferring.

### SUMMARY OF THE INVENTION

An information processing apparatus of the present disclosure includes: a first memory configured to store, for a certain period of time in real time, operation information when a robot is operating; a determination section configured to determine whether or not a predetermined trigger condition has occurred; and a writing section configured to extract specific operation information corresponding to a reason for occurrence of the trigger condition from the operation information stored in the first memory and write the specific operation information in a second memory in a case where the determination section determines that the trigger condition has occurred, the writing section dividing the specific operation information into a plurality of pieces of time-specific information for each predetermined unit time and writing the plurality of pieces of time-specific information one by one in the second memory.

An information processing apparatus of the present disclosure includes: a first memory configured to store, for a certain period of time in real time, operation information when a robot is operating; a determination section configured to determine whether or not a predetermined trigger condition has occurred; and a writing section configured to extract specific operation information corresponding to a reason for occurrence of the trigger condition from the operation information stored in the first memory and write the specific operation information in a second memory in a case where the determination section determines that the trigger condition has occurred, the writing section dividing the specific operation information into a plurality of pieces of type-specific information for each data type and writing the plurality of pieces of type-specific information one by one in the second memory.

An information processing method of the present disclosure includes: storing operation information when a robot is operating in a first memory in real time; determining whether or not a predetermined trigger condition has occurred; and extracting specific operation information corresponding to a reason for occurrence of the trigger condition from the operation information stored in the first memory and writing the specific operation information in a second memory in a case where the trigger condition is determined to have occurred in the determining, the specific operation information being divided into a plurality of pieces of time-specific information for each predetermined unit time and the plurality of pieces of time-specific information being written one by one in the second memory in the writing of the specific operation information.

An information processing method of the present disclosure includes: storing operation information when a robot is operating in a first memory in real time; determining whether or not a predetermined trigger condition has occurred; and extracting specific operation information corresponding to a reason for occurrence of the trigger condition from the operation information stored in the first memory and writing the specific operation information in a second memory in a case where the trigger condition is determined to have occurred in the determining, the specific operation information being divided into a plurality of pieces of type-specific information for each data type and the plurality of pieces of type-specific information being written one by one in the second memory in the writing of the specific operation information.

### BRIEF DESCRIPTION OF DRAWINGS

FIG. 1 is a diagram illustrating an overall configuration of a robot system according to a first embodiment.

FIG. 2 is a schematic diagram for explaining a method of writing specific operation information in a second memory.

FIG. 3 is a schematic diagram for explaining the method of writing the specific operation information in the second memory.

FIG. 4 is a schematic diagram for explaining the method of writing the specific operation information in the second memory.

FIG. 5 is a schematic diagram for explaining the method of writing the specific operation information in the second memory.

FIG. 6 is a flowchart for explaining an example of an information processing method.

FIG. 7 is a schematic diagram for explaining a method by which an information processing apparatus according to a second embodiment writes specific operation information in a second memory.

FIG. 8 is a schematic diagram for explaining the method by which the information processing apparatus according to the second embodiment writes the specific operation information in the second memory.

FIG. 9 is a schematic diagram for explaining the method by which the information processing apparatus according to the second embodiment writes the specific operation information in the second memory.

FIG. 10 is a schematic diagram for explaining the method by which the information processing apparatus according to the second embodiment writes the specific operation information in the second memory.

FIG. 11 is a schematic diagram for explaining the method by which the information processing apparatus according to the second embodiment writes the specific operation information in the second memory.

FIG. 12 is a schematic diagram for explaining the method by which the information processing apparatus according to the second embodiment writes the specific operation information in the second memory.

FIG. 13 is a flowchart for explaining an example of an information processing method.

### DETAILED DESCRIPTION OF THE INVENTION

Hereinafter, an information processing apparatus and an information processing method of the present disclosure will be described in detail on the basis of embodiments illustrated in the accompanying drawings.

### First Embodiment

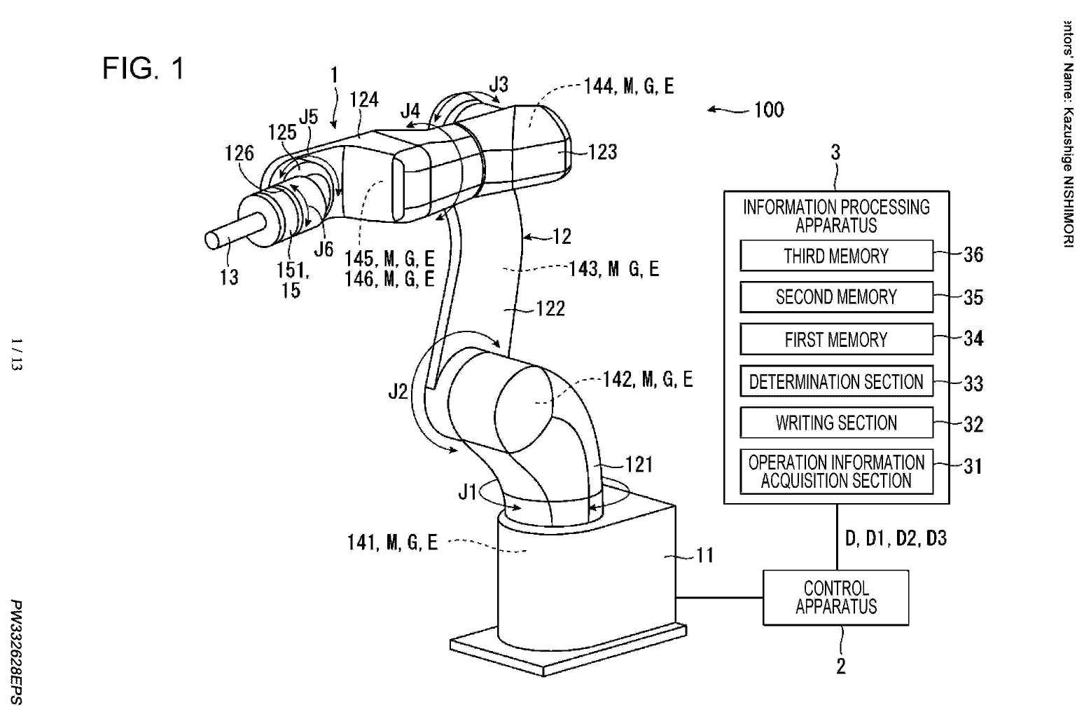

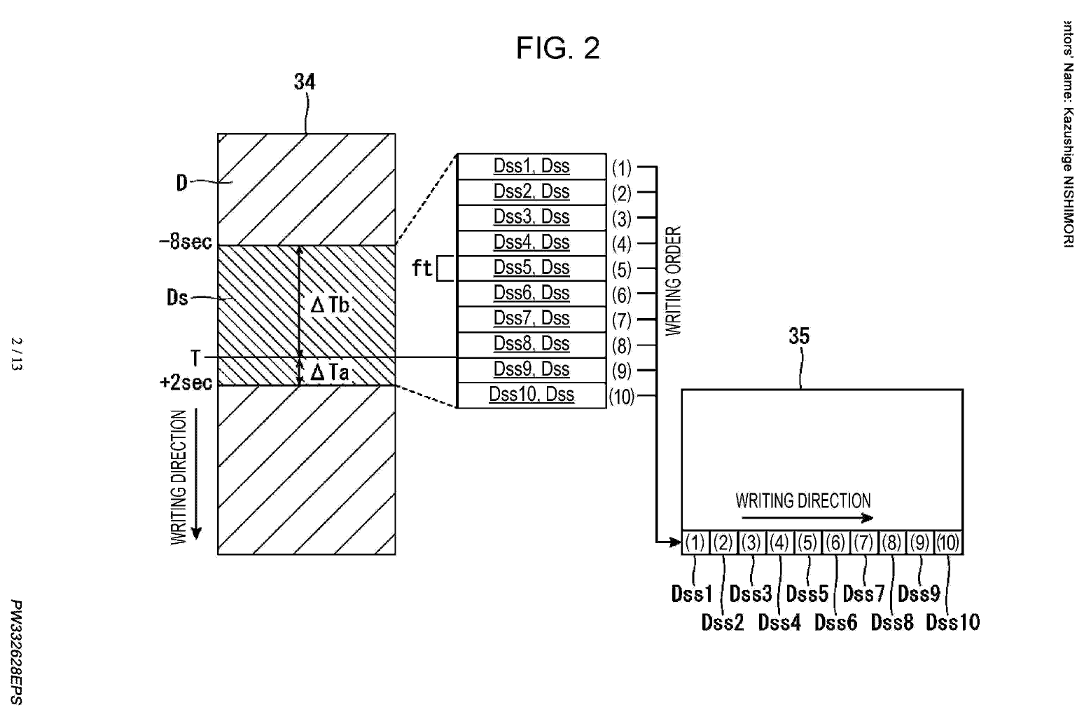

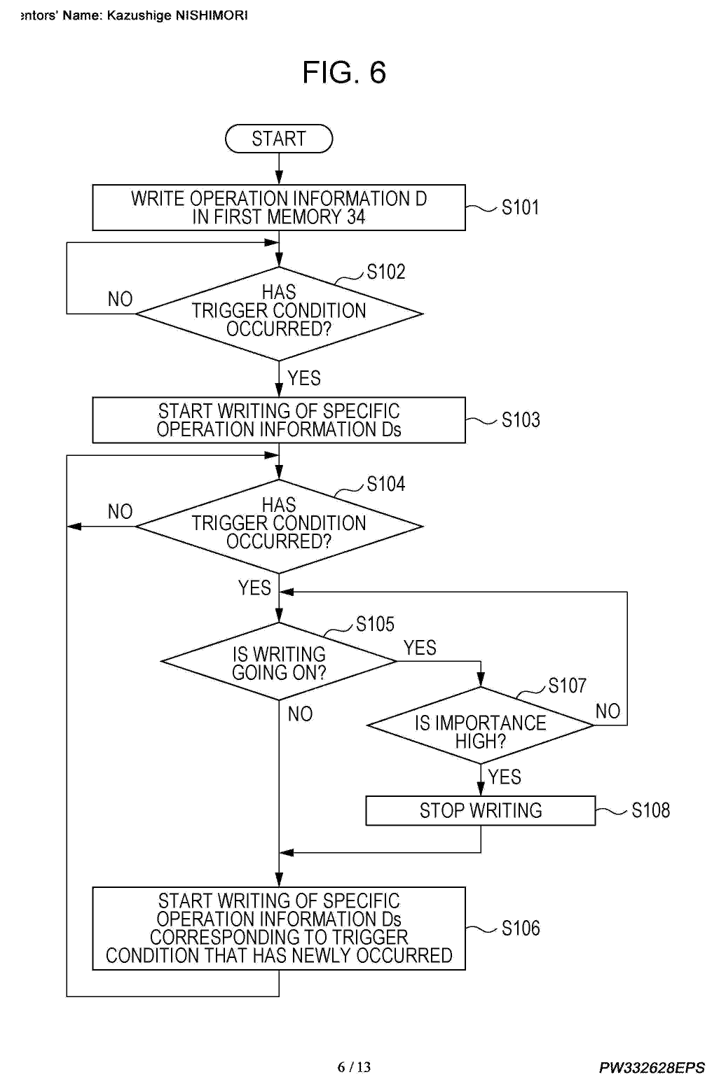

FIG. 1 is a diagram illustrating an overall configuration of a robot system according to a first embodiment. Each of FIGS. 2 to 5 is a schematic diagram for explaining a method of writing specific operation information in a second memory. FIG. 6 is a flowchart for explaining an example of an information processing method.

As illustrated in FIG. 1, a robot system 100 includes a robot 1, a control apparatus 2 that controls driving of the robot 1, and an information processing apparatus 3 that acquires and processes operation information when the robot 1 is operating.

Note that communication among the robot 1, the control apparatus 2, and the information processing apparatus 3 may be performed in a wired or wireless manner. Furthermore, although the control apparatus 2 and the information processing apparatus 3 are separately configured in the present embodiment, the present disclosure is not limited thereto, and for example, the information processing apparatus 3 may also serve as the control apparatus 2. In other words, the information processing apparatus 3 may be configured to control the driving of the robot 1 and acquire and process the operation information of the robot 1. Although the information processing apparatus 3 is connected to the robot 1 via the control apparatus 2 and is configured to acquire operation information D via the control apparatus 2 in the present embodiment, the present disclosure is not limited thereto, and the information processing apparatus 3 may be connected to the robot 1 and may be configured to acquire the operation information D from the robot 1. In addition, although the control apparatus 2 and the information processing apparatus 3 are disposed outside the robot 1 in the present embodiment, the present disclosure is not limited thereto, and for example, at least one of the control apparatus 2 and the information processing apparatus 3 may be accommodated in the robot 1, particularly, in a base 11, which will be described later.

Hereinafter, the robot 1, the control apparatus 2, and the information processing apparatus 3 configuring the robot system 100 will be described in order.

Robot 1

As illustrated in FIG. 1, the robot 1 is a six-axis vertical articulated robot having six drive axes and includes the base 11 fixed to a floor, a robot arm 12 rotatably coupled to the base 11, and an end effector 13 attached to a distal end of the robot arm 12.

The robot arm 12 includes a first arm 121 coupled to the base 11 to be rotatable about a first rotation axis J1, a second arm 122 coupled to the first arm 121 to be rotatable about a second rotation axis J2, a third arm 123 coupled to the second arm 122 to be rotatable about a third rotation axis J3, a fourth arm 124 coupled to the third arm 123 to be rotatable about a fourth rotation axis J4, a fifth arm 125 coupled to the fourth arm 124 to be rotatable about a fifth rotation axis J5, and a sixth arm 126 coupled to the fifth arm 125 to be rotatable about a sixth rotation axis J6.

The robot arm 12 includes a first drive unit 141 for rotating the first arm 121 about the first rotation axis J1 with respect to the base 11, a second drive unit 142 for rotating the second arm 122 about the second rotation axis J2 with respect to the first arm 121, a third drive unit 143 for rotating the third arm 123 about the third rotation axis J3 with respect to the second arm 122, a fourth drive unit 144 for rotating the fourth arm 124 about the fourth rotation axis J4 with respect to the third arm 123, a fifth drive unit 145 for rotating the fifth arm 125 about the fifth rotation axis J5 with respect to the fourth arm 124, and a sixth drive unit 146 for rotating the sixth arm 126 about the sixth rotation axis J6 with respect to the fifth arm 125.

Each of the drive units 141 to 146 includes, for example, a motor M, a reduction gear G that decelerates rotation of the motor M to output an increased torque, and an encoder E that detects the amount of rotation of the motor M. Also, the control apparatus 2 independently drives each motor M on the basis of a program for operating the robot 1, such that a tool center point (TCP) set at the distal end of the robot arm 12 moves to a target position in a desired posture and at a desired speed.

The end effector 13 is attached to the distal end of the robot arm 12, that is, the sixth arm 126. The end effector 13 is not particularly limited, and an end effector in accordance with a work to be executed by the robot 1 is appropriately mounted.

Also, the robot 1 includes at least one sensor 15. In the present embodiment, the robot 1 includes, as the sensor 15, a force sensor 151 that is disposed between the end effector 13 and the sixth arm 126 and detects a stress applied to the end effector 13. The force sensor 151 has three detection axes orthogonal to each other and can independently detect a translational force along each detection axis, that is, an axial force and a rotational force around each detection axis, that is, a torque. In addition, the robot 1 includes, as the sensor 15, the above-described encoder E provided in each of the drive units 141 to 146.

Although the robot 1 has been described above, the robot 1 is not particularly limited. For example, the robot 1 may be a horizontal articulated robot (SCARA robot) or a dual-arm robot including two robot arms 12.

Control Apparatus 2

The control apparatus 2 causes the robot arm 12 and the end effector 13 to perform predetermined motions and causes the robot 1 to perform a predetermined work by independently controlling driving of the motor M of each of the drive units 141 to 146 or controlling driving of the end effector 13. The control apparatus 2 is configured by, for example, a computer and includes a central processing unit (CPU), a random access memory (RAM), a read only memory (ROM) in which a program for operating the robot 1 (hereinafter, also referred to as an "operation program") is stored, and the like. In addition, the CPU reads and executes the operation program stored in the ROM, thereby achieving the functions as the control apparatus 2 that controls the driving of the robot 1.

Information Processing Apparatus 3

As illustrated in FIG. 1, the information processing apparatus 3 acquires and processes the operation information D when the robot 1 is operating. The information processing apparatus 3 is configured by, for example, a computer, and includes a CPU, a RAM, a ROM in which a program for executing an information processing method of the present disclosure (hereinafter, also referred to as an "information processing program") is stored, and the like. In addition, the CPU reads and executes the information processing program stored in the ROM, thereby achieving the functions as the information processing apparatus 3. However, the present disclosure is not limited thereto, and the information processing program may be stored in an apparatus other than the information processing apparatus 3, such as a server, for example.

Here, the operation information D of the present embodiment includes at least stress information D1 which is information regarding a stress applied to the end effector 13, speed information D2 which is information regarding the speed of the robot arm 12, and operation history information D3 which is information regarding an execution history of the operation program. In other words, the operation information D includes the stress information D1 and the speed information D2 which are detection results of the sensor 15.

Among these, the stress information D1 is obtained on the basis of a detection value of the force sensor 151 (sensor 15). On the other hand, the speed information D2 is particularly the speed of the TCP and is obtained on the basis of values output from the encoders E of the respective drive units 141 to 146. The operation history information D3 is information indicating how the robot 1 has actually operated in response to the operation program and is obtained on the basis of, for example, values output from the encoders E of the respective drive units 141 to 146. However, each of methods for acquiring the stress information D1, the speed information D2, and the operation history information D3 is not particularly limited.

Furthermore, information included in the operation information D is not limited to the stress information D1, the speed information D2, and the operation history information D3, and only one of these may be included therein, or different information from these may be included therein. Also, the "different information" may include, for example, information regarding an internal temperature of the robot 1 detected by a temperature sensor as the sensor 15 disposed in the robot arm 12, information regarding vibration of the robot arm 12 detected by an inertial sensor as the sensor 15 disposed at the robot arm 12, information regarding whether or not there has been something entering a movable area of the robot 1 as obtained by disposing a camera as the sensor 15 for imaging the surroundings of the robot 1.

As illustrated in FIG. 1, the information processing apparatus 3 includes an operation information acquisition section 31, a writing section 32, a determination section 33, a first memory 34, a second memory 35, and a third memory 36. These functions are implemented by the above-described hardware configuration.

The operation information acquisition section 31 acquires the above-described operation information D from the robot 1 via the control apparatus 2 in real time when the robot 1 is operating.

The writing section 32 has a function of writing the operation information D acquired by the operation information acquisition section 31 in the first memory 34 (hereinafter, also referred to as an "operation information writing function") and a function of writing specific operation information Ds extracted from the operation information D in the second memory 35 (hereinafter, also referred to as a "specific operation information writing function"). Each of these functions may be configured to be performed by one processor or may be configured to be performed by a plurality of different processors. In a case where the functions are performed by a plurality of different processors, the processors are collectively referred to as the writing section 32. Furthermore, each function may be configured to use a data transfer method such as direct memory access (DMA).

Note that the expression that the writing section 32 "writes" the operation information D in the first memory 34 means that the first memory 34 stores the operation information D as data in a predetermined format. At this time, the writing section 32 may copy the operation information D from the original storage location and write the operation information D in the first memory 34, or may delete the operation information D from the original storage location and then write the operation information D in the first memory 34. The same applies to the writing section 32 writing the specific operation information Ds in the second memory 35 and the writing section 32 writing the specific operation information Ds in the third memory 36.

Also, the first memory 34 is a storage device provided in the information processing apparatus 3 and is configured by a volatile memory such as a ring buffer. For this reason, the first memory 34 stores the operation information D, which is written by the writing section 32, for a predetermined period of time in real time, and overwrites the oldest operation information D with the latest operation information D when the predetermined period of time elapses. According to such a configuration, it is possible to effectively suppress an increase in size of the first memory 34, an increase in memory capacity, an increase in cost, and the like. Note that although the "predetermined period of time" is not particularly limited, the predetermined period of time can be, for example, 30 seconds.

Also, the second memory 35 is a storage device detachably connected to the information processing apparatus 3. As the second memory 35, an external solid state drive (SSD), a hard disk drive (HDD), an SD card, a CD-ROM, a USB memory, or the like can be used, for example. In this manner, the second memory 35 in which the operation information D is stored can be connected to another device, and the operation information D can be reproduced or analyzed by the device, by making the second memory 35 attachable to and detachable from the information processing apparatus 3. Note that although the second memory 35 is a constituent element of the information processing apparatus 3 in the present embodiment, the present disclosure is not limited thereto, and the second memory 35 may not be a constituent element of the information processing apparatus 3.

Also, the third memory 36 is a storage device provided in the information processing apparatus 3. Such a third memory 36 may be a volatile memory or a non-volatile memory. However, the third memory 36 is not limited thereto and may be a storage device, like the above- described second memory 35, detachably connected to the information processing apparatus 3. Note that although the third memory 36 is a constituent element of the information processing apparatus 3 in the present embodiment, the present disclosure is not limited thereto, and the third memory 36 may not be a constituent element of the information processing apparatus 3.

The determination section 33 determines whether or not a predetermined trigger condition has occurred. The expression "a predetermined trigger condition has occurred" means that a condition under which the writing section 32 is to perform the specific operation information writing function has been satisfied. Note that although the trigger condition is not particularly limited, the trigger condition may include, for example, (a) a condition that a stress applied to the end effector 13 has exceeded a predetermined value, (b) a condition that the speed of the robot arm 12 has exceeded a predetermined value, (c) a condition that the robot 1 has stopped for some reason such as disconnection of a main power supply due to power failure or the like, collision against an intruding object or the like, emergency stop due to pressing of an emergency stop switch, (d) a condition that a peculiar symptom that cannot normally occur has appeared.

Further, a plurality of levels of importance is set for the trigger conditions. For example, (a) and (b) described above are set as trigger conditions at a "low level of importance" which is the lowest level of importance, (d) described above is set as a trigger condition at a "medium level of importance" which is the middle level of importance, and (c) described above is set as a trigger condition at a "high level importance" which is the highest level importance in the present embodiment. In other words, the levels of importance satisfy (a) = (b) < (d) < (c). Note that a user can appropriately set content of the trigger conditions and which trigger condition is set to which level of importance, in accordance with the type of the sensor 15 included in the robot 1, content of the work performed by the robot 1, and the like. In addition, the number of levels of importance of the trigger conditions is not limited to three, namely "low", "medium", and "high" as described above, and may be two or four or more. In addition, the levels of importance may not be set.

Next, the above-described specific operation information writing function will be described. In a case where the determination section 33 determines that "the trigger condition has occurred", the writing section 32 extracts the specific operation information Ds corresponding to a reason for occurrence of the trigger condition from the operation information D stored in the first memory 34 and writes the specific operation information Ds in the second memory 35. At this time, the writing section 32 performs compression processing (compression encoding processing) on the specific operation information Ds and writes the specific operation information Ds in the second memory 35. In this manner, the second memory 35 can store a sufficient amount of specific operation information Ds. However, the present disclosure is not limited thereto, and the writing section 32 may write the specific operation information Ds in the second memory 35 without performing the compression processing thereon.

In a case where the above-described trigger condition (a) has occurred, for example, information including the operation history information D3 and the stress information D1 in the operation information D stored in the first memory 34 is stored in the second memory 35 as the specific operation information Ds. In addition, in a case where the above-described trigger condition (b) has occurred, for example, information including the operation history information D3 and the speed information D2 in the operation information D stored in the first memory 34 is stored in the second memory 35 as the specific operation information Ds. Moreover, in a case where the above-described trigger conditions (c) and (d) have occurred, for example, information including the operation history information D3, the speed information D2, and the stress information D1 in the operation information D stored in the first memory 34 is stored in the second memory 35 as the specific operation information Ds.

In other words, the type of data to be included in the specific operation information Ds differs depending on the type of trigger condition that has occurred. According to such a configuration, only necessary data can be included in the specific operation information Ds for each type of trigger condition that has occurred, and it is thus possible to suppress the data amount of the specific operation information Ds to be small. Therefore, the writing of the specific operation information Ds in the second memory 35 is finished in a shorter period of time. Furthermore, the capacity of the second memory 35 can also be suppressed to be small. However, the present disclosure is not limited thereto, and the type of data to be included in the specific operation information Ds may be the same regardless of the type of trigger condition. In the case of the present embodiment, for example, information including the operation history information D3, the speed information D2, and the stress information D1 may be stored in the second memory 35 as the specific operation information Ds regardless of which of the above trigger conditions (a), (b), (c), and (d) has occurred. Here, in a case where the entire specific operation information Ds is written in the second memory 35 as one piece of information (file), the data amount of the information becomes large, and the processing time required for the writing in the second memory 35 thus becomes long. Therefore, there is an increased risk of occurrence of an error during writing, stop of driving of the apparatus due to power failure or the like, or a writing error due to a failure or the like of the apparatus (hereinafter, also simply referred to as a "writing error"). If a writing error occurs during the writing, there is a concern that the entire specific operation information Ds may be damaged, the writing in the second memory 35 may fail, or the specific operation information Ds may be lost.

FIG. 2 illustrates an image diagram of the operation information D stored in the first memory 34 and the specific operation information Ds to be written in the second memory 35. In the image diagram, information is written in the first memory 34 in order from the upper end side, and conversely, information is written in the second memory 35 in order from the lower end side. As illustrated in the drawing, in a case where the clock time at which a trigger condition has occurred is defined as T, the specific operation information Ds includes information corresponding to a predetermined period of time ΔTb before the clock time T and information corresponding to a predetermined period of time ΔTa after the clock time T. In other words, the specific operation information Ds is information from the clock time (T - ΔTb) to the clock time (T + ΔTa). In this manner, the specific operation information Ds includes the information before and after the clock time T, and it is thus possible to accurately recognize states of the robot 1 before and after the clock time T.

Although the predetermined periods of time ΔTb and ΔTa are not particularly limited, each of the predetermined periods of time ΔTb and ΔTa can be set to be, for example, equal to or greater than 1 second and equal to or less than 10 seconds. Furthermore, the predetermined periods of time ΔTb and ΔTa can be different depending on the type of trigger condition. In particular, since a behavior of the robot 1 before the clock time T is more important than a behavior of the robot 1 after the clock time T for analysis of the behaviors of the robot 1, it is preferable that ΔTb > ΔTa be satisfied, and hereinafter, ΔTb = 8 seconds and ΔTa = 2 seconds are set for the above trigger conditions (a), (b), and (c) while ΔTb = ∞ seconds and ΔTa = 0 seconds are set for the above trigger condition (d) for convenience of description.

Therefore, the writing section 32 divides the specific operation information Ds into a plurality of pieces of time-specific information Dss for each predetermined unit time ft and sequentially writes the plurality of pieces of time-specific information Dss one by one in the second memory 35 as illustrated in FIG. 2 in the present embodiment. For example, the predetermined unit time ft is set to 1 second, and the specific operation information Ds for a total of 10 seconds from the clock time (T - 8 seconds) to the clock time (T + 2 seconds) is divided into a total of 10 pieces of time-specific information Dss for each second in the present embodiment. In other words, the specific operation information Ds is divided into time-specific information Dss1 from the clock time (T - 8 seconds) to the clock time (T - 7 seconds), time-specific information Dss2 after the clock time (T - 7 seconds) until the clock time (T - 6 seconds), time-specific information Dss3 after the clock time (T - 6 seconds) until the clock time (T - 5 seconds), time-specific information Dss4 after the clock time (T - 5 seconds) until the clock time (T - 4 seconds), time-specific information Dss5 after the clock time (T - 4 seconds) until the clock time (T - 3 seconds), time-specific information Dss6 after the clock time (T - 3 seconds) until the clock time (T - 2 seconds), time-specific information Dss7 after the clock time (T - 2 seconds) until the clock time (T - 1 seconds), time-specific information Dss8 after the clock time (T - 1 seconds) until the clock time T, time-specific information Dss9 after the clock time T until the clock time (T + 1 seconds), and time-specific information Dss10 after the clock time (T + 1 seconds) until the clock time (T + 2 seconds).

Then, the time-specific information Dss1 to Dss10 is written in the second memory 35 one by one in a predetermined order. According to such a writing method, the data amount of each piece of time-specific information Dss can be suppressed to be small. Therefore, even if a writing error occurs while the specific operation information Ds is being written in the second memory 35, at least the time-specific information Dss that has completely been written until then is appropriately stored in the second memory 35. In other words, there is an increased possibility that even a portion of the specific operation information Ds can be stored in the second memory 35, and the concern that the entire specific operation information Ds may be lost decreases. Note that although the plurality of pieces of time-specific information Dss is assumed to be written one by one in the second memory 35, the time-specific information Dss1 from the clock time (T - 8 seconds) to the clock time (T - 7 seconds) and the time-specific information Dss2 after the clock time (T - 7 seconds) until the clock time (T - 6 seconds) may be included in one piece of time-specific information Dss, for example.

Note that, among the pieces of time-specific information Dss1 to Dss10, the time-specific information Dss8 is "first time-specific information", the time-specific information Dss9 is "second time-specific information", and the time-specific information Dss7 is "third time-specific information" in the present embodiment.

The order in which the time-specific information Dss1 to Dss10 is written in the second memory 35 is not particularly limited, and as illustrated in FIG. 2, for example, the time-specific information Dss1 to Dss10 may be simply written in order from the past to the future. In other words, the time-specific information Dss1, the time-specific information Dss2, the time-specific information Dss3, the time-specific information Dss4, the time-specific information Dss5, the time-specific information Dss6, the time-specific information Dss7, the time-specific information Dss8, the time-specific information Dss9, and the time-specific information Dss10 may be written one by one in this order in the second memory 35.

However, it is preferable to write the information in the second memory 35 in a descending order of levels of importance rather than in a simple order as described above. The levels of importance vary depending on the type of trigger condition, the type of data desired to be acquired by the user, and the like and can be appropriately set by the user.

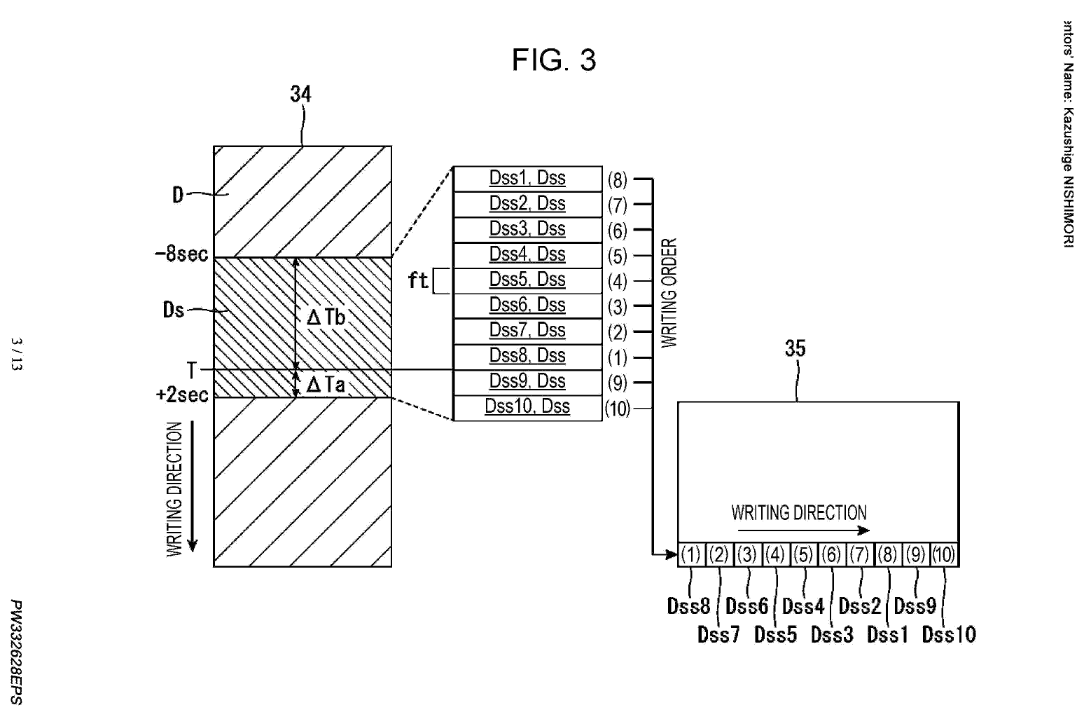

In a case where the above-described trigger condition (a) or (b) has occurred, for example, data before the clock time T at which the trigger condition has occurred, particularly data immediately before the clock time T is important. Therefore, it is preferable that the writing section 32 sequentially write data from the clock time T toward the past and then sequentially write data from the clock time T toward the future in the second memory 35 as illustrated in FIG. 3, for example. In other words, it is preferable to write the time-specific information Dss8, the time-specific information Dss7, the time-specific information Dss6, the time-specific information Dss5, the time-specific information Dss4, the time-specific information Dss3, the time-specific information Dss2, the time-specific information Dss1, the time-specific information Dss9, and the time-specific information Dss10 one by one in this order in the second memory 35. According to such a writing order, even if a writing error occurs while the specific operation information Ds is being written in the second memory 35, there is an increased possibility that at least the time-specific information Dss at a high level of importance is appropriately stored in the second memory 35.

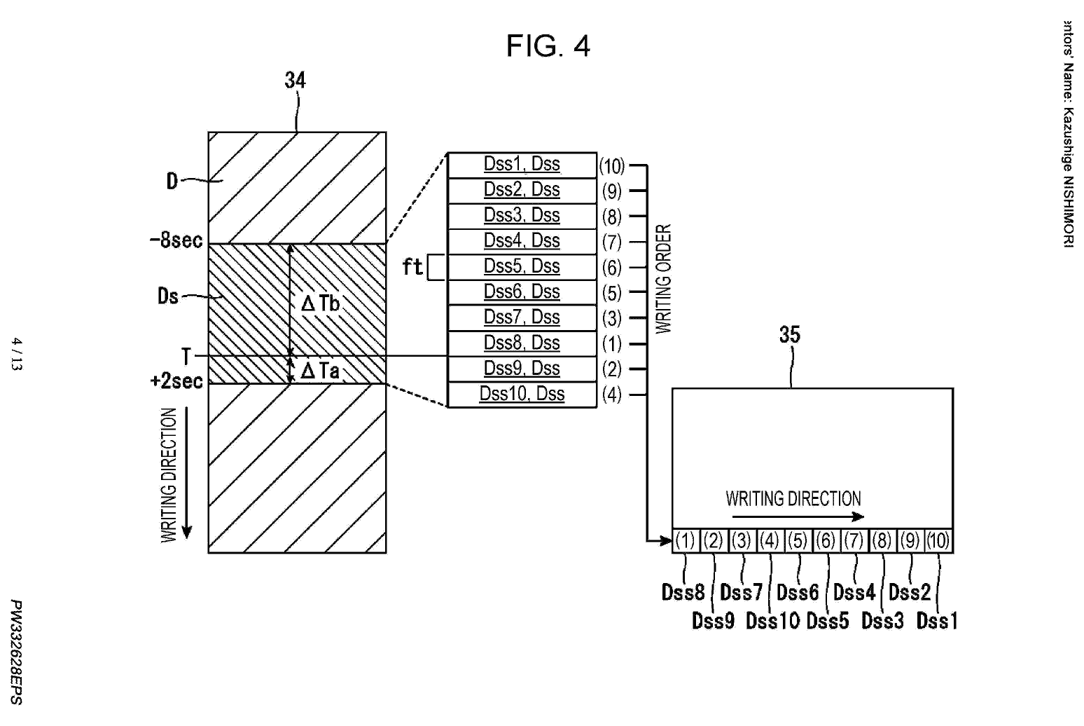

Furthermore, in a case where the above-described trigger condition (c) has occurred, for example, data at a clock time close to the clock time T at which the trigger condition has occurred is important. Therefore, the writing section 32 preferably writes data in the second memory 35 in ascending order of a time difference from the clock time T as illustrated in FIG. 4, for example. In other words, it is preferable to write the time-specific information Dss8, the time-specific information Dss9, the time-specific information Dss7, the time-specific information Dss10, the time-specific information Dss6, the time-specific information Dss5, the time-specific information Dss4, the time-specific information Dss3, the time-specific information Dss2, and the time-specific information Dss1 one by one in this order in the second memory 35. According to such a writing order, even if a writing error occurs while the specific operation information Ds is being written in the second memory 35, there is an increased possibility that at least the time-specific information Dss at a high level of importance is appropriately stored in the second memory 35.

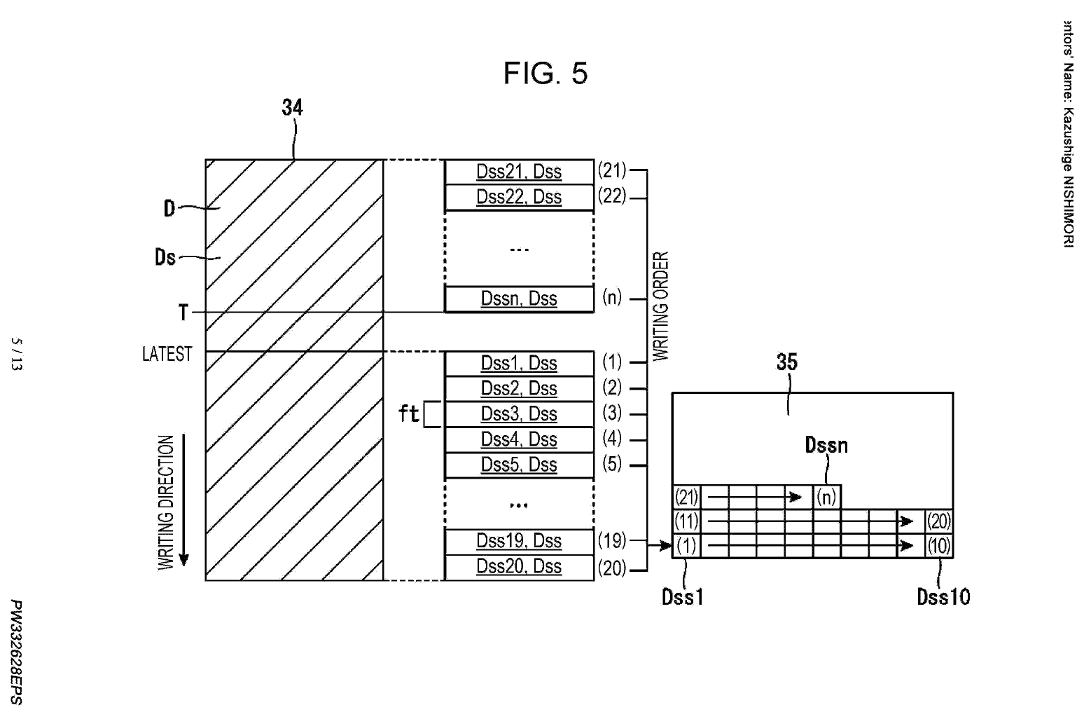

In addition, in a case where the above-described trigger condition (d) has occurred, for example, data before the clock time T at which the trigger condition has occurred is important. It is also necessary to obtain information more retrospectively for analysis. Therefore, the writing section 32 preferably writes the oldest time-specific information Dss stored in the first memory 34 to the time-specific information Dss at the clock time T in the order from the older one in the second memory 35 as illustrated in FIG. 5, for example. According to such a writing order, even if a writing error occurs while the specific operation information Ds is being written in the second memory 35, there is an increased possibility that at least the time-specific information Dss at a high level of importance is appropriately stored in the second memory 35.

The method of writing the specific operation information Ds in the second memory 35 by the writing section 32 has been described above. Here, a processing method in a case where another trigger condition (hereinafter, also referred to as a "second trigger condition" for convenience of description) occurs while the writing section 32 is writing the specific operation information Ds in the second memory 35 in response to a certain trigger condition (hereinafter, also referred to as a "first trigger condition" for convenience of description) occurring will be described.

In a case where a level of importance of the second trigger condition is lower than that of the first trigger condition, or in a case where the level of importance of the second trigger condition is the same as that of the first trigger condition, the writing of the specific operation information Ds corresponding to the second trigger condition in the second memory 35 is started after the writing of the specific operation information Ds corresponding to the first trigger condition in the second memory 35 is finished.

On the other hand, in a case where the level of importance of the second trigger condition is higher than that of the first trigger condition, writing of the specific operation information Ds corresponding to the first trigger condition in the second memory 35 is temporarily stopped, and writing of the specific operation information Ds corresponding to the second trigger condition in the second memory 35 is started. According to such a writing method, the specific operation information Ds corresponding to the trigger condition at a higher level of importance can be preferentially written in the second memory 35, and data at a high level of importance can be more reliably stored in the second memory 35.

Note that at this time, the writing section 32 writes the time-specific information Dss, which has not completely been written in the second memory 35, of the specific operation information Ds corresponding to the first trigger condition in the third memory 36 and evacuates the time-specific information Dss from the first memory 34. In a case where the second trigger condition at a higher level of importance has occurred during writing of the time-specific information Dss1 in the example illustrated in FIG. 3, for example, the writing section 32 writes the time-specific information Dss1, Dss9, and Dss10, which have not completely been written in the second memory 35 until that point, in the third memory 36 and evacuates the time-specific information Dss1, Dss9, and Dss10 from the first memory 34. It is thus possible to suppress overwriting and deletion of the time-specific information Dss.

Then, after the writing of the specific operation information Ds corresponding to the second trigger condition in the second memory 35 is finished, the writing section 32 writes, in the second memory 35, the time-specific information Dss (remaining portion) written in the third memory 36. As a result, the entire specific operation information Ds corresponding to the first trigger condition can be written in the second memory 35. However, the present disclosure is not limited thereto, and the time-specific information Dss, which has not completely been written in the second memory 35, of the specific operation information Ds corresponding to the first trigger condition may not be written in the second memory 35. This is because there is a high possibility that important information among the ten pieces of time-specific information Dss included in the specific operation information Ds has already been written in the second memory 35, although it depends on what time the second trigger condition has occurred.

The specific operation information writing function has been described above. Next, an example of the information processing method of the present disclosure will be described using the flowchart illustrated in FIG. 6.

First, in Step S101, the information processing apparatus 3 stores the operation information D when the robot 1 is operating in the first memory 34 in real time. In other words, the operation information acquisition section 31 acquires the operation information D from the robot 1, and the writing section 32 writes the acquired operation information D in the first memory 34. Step S101 is an operation information storing step.

Next, in Step S102, the determination section 33 determines whether or not a trigger condition has occurred. Step S102 is a determination step.

In a case where the determination section 33 determines that "a trigger condition has occurred" in Step S102, the writing section 32 starts writing of the specific operation information Ds corresponding to the trigger condition that has occurred in the second memory 35 in Step S103. In the writing, the specific operation information Ds is divided into a plurality of pieces of time-specific information Dss, and the plurality of pieces of time-specific information Dss is written one by one in the second memory 35 in a preset order. Step S103 is a specific operation information writing step.

Next, in Step S104, the determination section 33 determines whether or not a new trigger condition has occurred.

In a case where the determination section 33 determines that "a trigger condition has occurred" in Step S104, the determination section 33 determines, in Step S105, whether or not the writing of the specific operation information Ds corresponding to the trigger condition that has occurred earlier in the second memory 35 has been finished.

In a case where the determination section 33 determines that "writing has been finished" in Step S105, the writing section 32 starts writing of the specific operation information Ds corresponding to the trigger condition that has newly occurred in the second memory 35 in Step S106. Then, the processing returns to Step S104.

On the other hand, in a case where the determination section 33 determines that "the writing has not been finished" in Step S105, the determination section 33 determines, in Step S107, whether or not a level of importance of the trigger condition that has newly occurred is higher than a level of importance of the trigger condition that has occurred earlier.

In a case where the determination section 33 determines that "the level of importance is low" or "the level of importance is the same" in Step S107, the processing returns to Step S105. In other words, an end of the writing of the specific operation information Ds corresponding to the trigger condition that has occurred earlier in the second memory 35 is waited, the processing proceeds to Step S106 after the end, and the writing of the specific operation information Ds corresponding to the trigger condition that has newly occurred in the second memory 35 is started.

On the other hand, in a case where the determination section 33 determines that "the level of importance is high" in Step S107, the writing section 32 stops the writing of the specific operation information Ds corresponding to the trigger condition that has occurred earlier in the second memory 35 in the middle in Step S108, and the processing proceeds to Step S106 to start the writing of the specific operation information Ds corresponding to the trigger condition that has newly occurred in the second memory 35. Note that although not illustrated in the flowchart, in a case where the processing proceeds to Step S106 via Step S108, the writing of the remaining portion of the specific operation information Ds corresponding to the trigger condition that has occurred earlier in the second memory 35 may be restarted after the writing of the specific operation information Ds corresponding to the trigger condition that has newly occurred in the second memory 35 is finished.

According to such an information processing method, even if a writing error occurs while the specific operation information Ds is being written in the second memory 35, at least the time-specific information Dss that has completely been written until then is appropriately stored in the second memory 35. In other words, even a portion of the specific operation information Ds can be stored in the second memory 35, and the concern that the entire specific operation information Ds may be lost decreases.

The information processing apparatus 3 and the information processing method by the information processing apparatus 3 according to the present embodiment have been described above. As described above, such an information processing apparatus 3 includes: the first memory 34 configured to store, for a certain period of time in real time, the operation information D when the robot 1 is operating; the determination section 33 configured to determine whether or not a predetermined trigger condition has occurred; and the writing section 32 configured to extract the specific operation information Ds corresponding to a reason for occurrence of the trigger condition from the operation information D stored in the first memory 34 and write the specific operation information Ds in the second memory 35 in a case where the determination section 33 determines that "a trigger condition has occurred". Also, the writing section 32 divides the specific operation information Ds into a plurality of pieces of time-specific information Dss for each predetermined unit time ft and writes the plurality of pieces of time-specific information Dss one by one in the second memory 35. According to such a configuration, even if a writing error occurs while the specific operation information Ds is being written in the second memory 35, at least the time-specific information Dss that has completely been written until then is appropriately stored in the second memory 35. In other words, there is an increased possibility that even a portion of the specific operation information Ds can be stored in the second memory 35, and the concern that the entire specific operation information Ds may be lost decreases.

As described above, the specific operation information Ds includes the time-specific information Dss8 as the first time-specific information which is the time-specific information Dss before the clock time T at which the trigger condition has occurred and the time-specific information Dss9 as the second time-specific information which is the time-specific information Dss after the clock time T at which the trigger condition has occurred. Also, the writing section 32 writes the time-specific information Dss8 in the second memory 35 and then writes the time-specific information Dss9 in the second memory 35. In analysis of the specific operation information Ds, information before the clock time T is particularly effective. Therefore, it is possible to preferentially write the time-specific information Dss8, which is more important information, in the second memory 35 by adopting such a configuration. Therefore, even if a writing error occurs while the specific operation information Ds is being written in the second memory 35, there is an increased possibility that at least the time-specific information Dss8 at a high level of importance is appropriately stored in the second memory 35.

As described above, the specific operation information Ds includes the time-specific information Dss7 as the third time-specific information which is the time-specific information Dss before the time-specific information Dss8. Also, the writing section 32 writes the time-specific information Dss9 in the second memory 35 and then writes the time-specific information Dss7 in the second memory 35. In analysis of the specific operation information Ds, information before the clock time T is effective, and information for a period of time close to the clock time T is also effective. Therefore, it is possible to preferentially write the information in the closest period of time before and after the clock time T in the second memory 35 by adopting such a configuration. Therefore, even if a writing error occurs while the specific operation information Ds is being written in the second memory 35, there is an increased possibility that at least information for the closest period of time before and after the clock time T at a high level of importance is stored in the second memory 35.

As described above, the information processing method by the information processing apparatus 3 includes: Step S101 as the operation information storing step of storing the operation information D when the robot 1 is operating in the first memory 34 in real time; Step S102 as the determination step of determining whether or not a predetermined trigger condition has occurred; and Step S103 as the specific operation information writing step of extracting the specific operation information Ds corresponding to a reason for occurrence of the trigger condition from the operation information D stored in the first memory 34 and writing the specific operation information Ds in the second memory 35 in a case where it is determined that "the trigger condition has occurred" in Step S102. Then, in Step S103, the specific operation information Ds is divided into the plurality of pieces of time-specific information Dss for each predetermined unit time ft, and the plurality of pieces of time-specific information Dss is written one by one in the second memory 35. According to such a method, even if a writing error occurs while the specific operation information Ds is being written in the second memory 35, at least the time-specific information Dss that has completely been written until then is appropriately stored in the second memory 35. In other words, there is an increased possibility that even a portion of the specific operation information Ds can be stored in the second memory 35, and the concern that the entire specific operation information Ds may be lost decreases.

### Second Embodiment

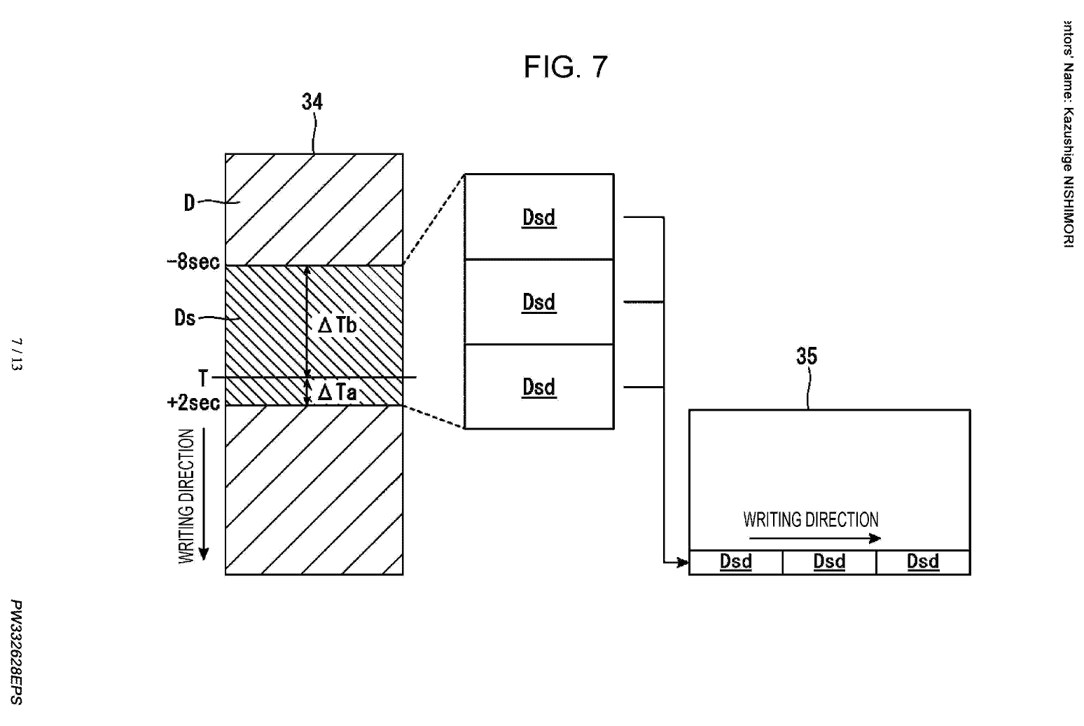

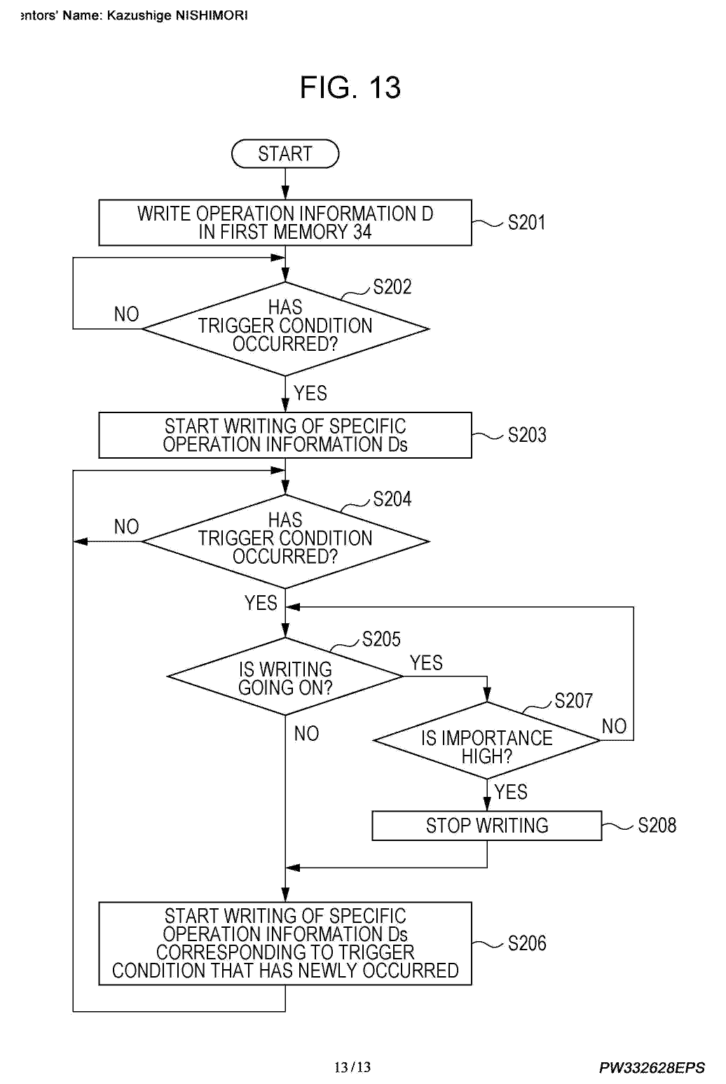

Each of FIGS. 7 to 12 is a schematic diagram for explaining a method by which an information processing apparatus according to a second embodiment writes specific operation information in a second memory. FIG. 13 is a flowchart for explaining an example of an information processing method.

An information processing apparatus 3 of the present embodiment is similar to that of the above-described first embodiment except that a method of writing specific operation information Ds in the second memory 35 is different. Note that in the following description, the present embodiment will be described with a focus on differences from the above-described first embodiment, and description of similar matters will be omitted. In each of the drawings of the present embodiment, the same reference numerals are assigned to the same configurations as those of the above-described embodiment.

As described above, the writing section 32 of the first embodiment divides the specific operation information Ds into the plurality of pieces of time-specific information Dss for each predetermined unit time ft and sequentially writes the plurality of pieces of time-specific information Dss one by one in the second memory 35. In contrast, a writing section 32 of the present embodiment divides specific operation information Ds into a plurality of pieces of type-specific information Dsd for each data type and writes the plurality of pieces of type-specific information Dsd one by one in the second memory 35 as illustrated in FIG. 7. Even with such a configuration, it is possible to achieve effects similar to those of the above-described first embodiment. In other words, according to such a writing method, it is possible to suppress the data amount of each piece of type-specific information Dsd to be small. Therefore, even if a writing error occurs while the specific operation information Ds is being written in the second memory 35, at least the type-specific information Dsd that has completely been written until then is appropriately stored in the second memory 35. In other words, there is an increased possibility that even a portion of the specific operation information Ds can be stored in the second memory 35, and the concern that the entire specific operation information Ds may be lost decreases.

Hereinafter, a specific operation information writing function of the writing section 32 will be described. In a case where a determination section 33 determines that "a trigger condition has occurred", the writing section 32 extracts the specific operation information Ds corresponding to a reason for occurrence of the trigger condition from operation information D stored in a first memory 34 and writes the specific operation information Ds in a second memory 35. At this time, the writing section 32 divides the specific operation information Ds into a plurality of pieces of type-specific information Dsd for each data type and sequentially writes the plurality of pieces of type-specific information Dsd one by one in the second memory 35.

Here, the specific operation information Ds includes first type-specific information related to a first data type and second type-specific information related to a second data type that is different from the first data type. In the case of the present embodiment, the first data type is a detection result of a sensor 15, while the second data type is an execution history of an operation program. Therefore, the first type-specific information is stress information D1 and speed information D2, while the second type-specific information is operation history information D3. However, the first and second data types are not particularly limited and can be appropriately set in accordance with a configuration of a robot 1, content of a work performed by the robot 1, and the like.

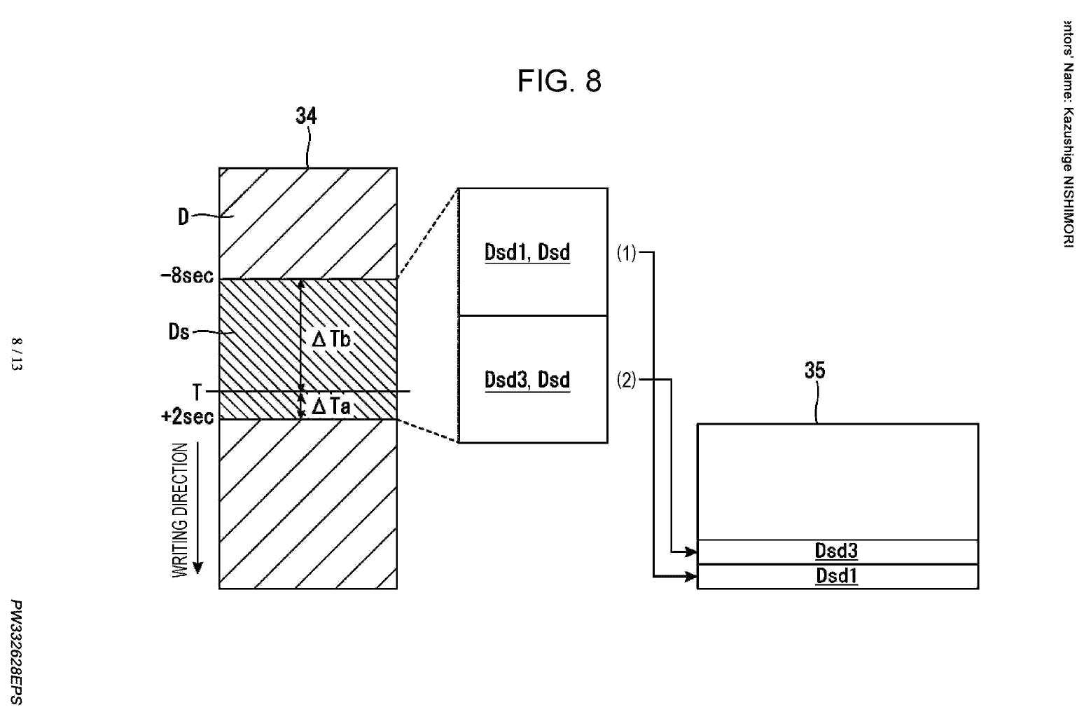

For example, the specific operation information Ds corresponding to the above-described trigger condition (a) includes the operation history information D3 and the stress information D1 as described above. Therefore, in this case, the writing section 32 divides the specific operation information Ds into the type-specific information Dsd3 including the operation history information D3 and the type-specific information Dsd1 including the stress information D1 and sequentially writes these two pieces of type-specific information Dsd1 and Dsd3 one by one in the second memory 35 as illustrated in FIG. 8.

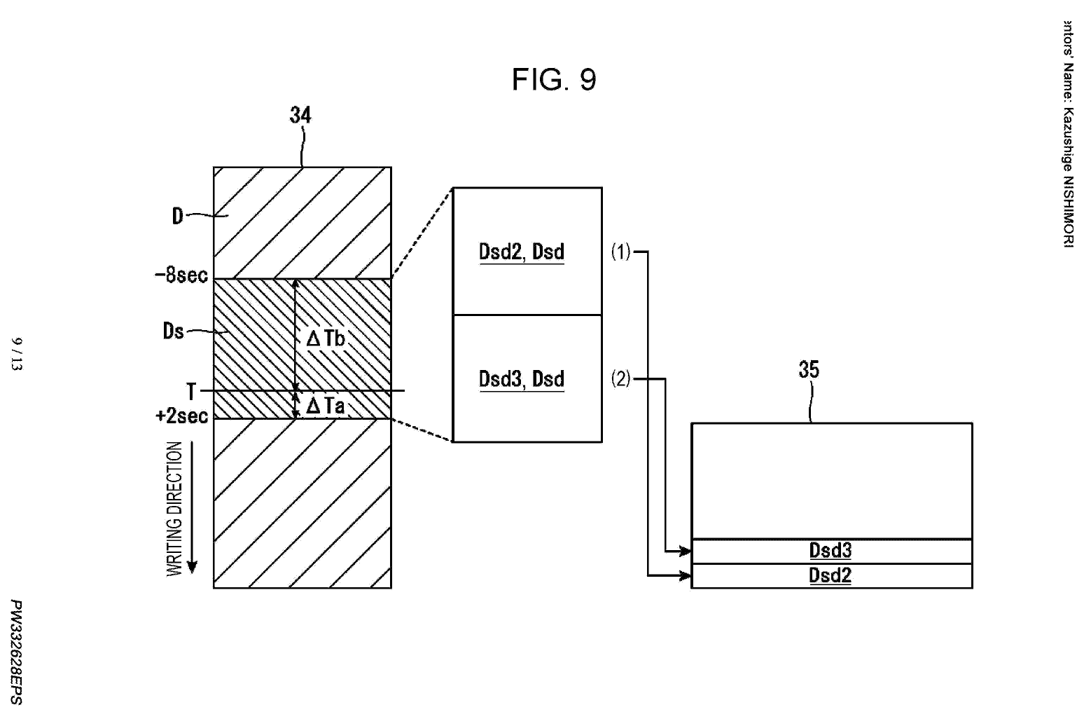

Also, the specific operation information Ds corresponding to the above-described trigger condition (b) includes the operation history information D3 and the speed information D2. Therefore, in this case, the writing section 32 divides the specific operation information Ds into the type-specific information Dsd3 including the operation history information D3 and the type-specific information Dsd2 including the speed information D2 and sequentially writes these two pieces of type-specific information Dsd2 and Dsd3 one by one in the second memory 35 as illustrated in FIG. 9.

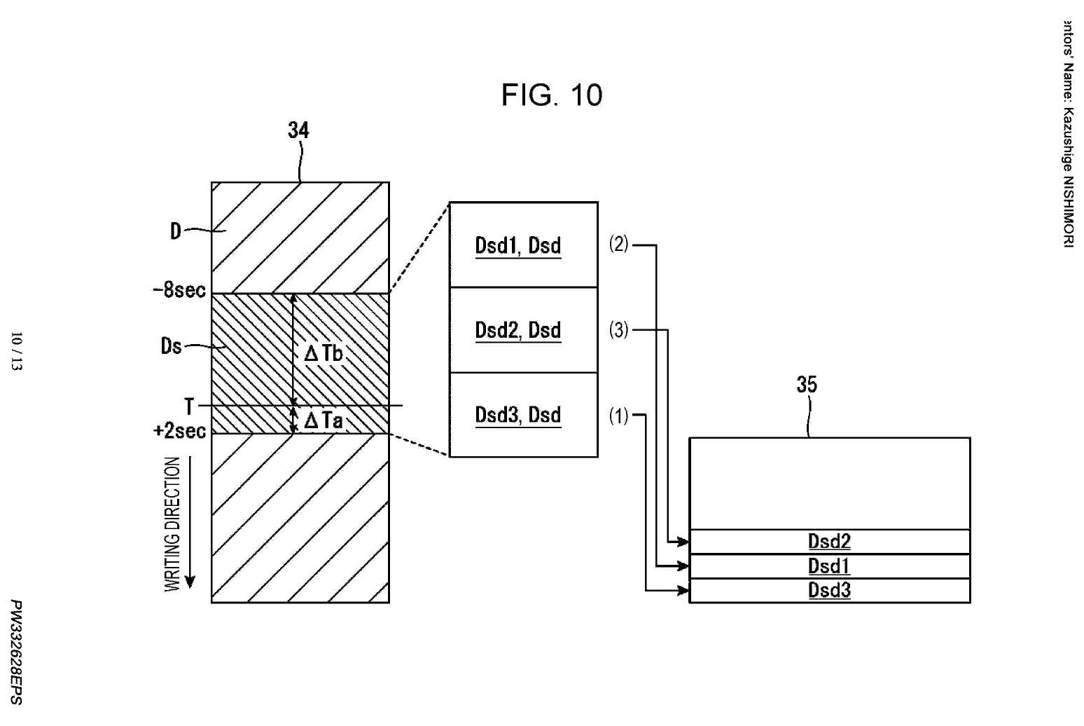

Also, the specific operation information Ds corresponding to the above-described trigger conditions (c) and (d) includes the operation history information D3, the speed information D2, and the stress information D1. Therefore, in this case, the writing section 32 divides the specific operation information Ds into the type-specific information Dsd3 including the operation history information D3, the type-specific information Dsd2 including the speed information D2, and the type-specific information Dsd1 including the stress information D1 and sequentially writes these three pieces of type-specific information Dsd1, Dsd2, and Dsd3 one by one in the second memory 35 as illustrated in FIG. 10.

Note that although the order in which the plurality of pieces of type-specific information Dsd is written in the second memory 35 is not particularly limited, the writing order is determined for each type of trigger condition in the present embodiment. This is because levels of importance among the plurality of pieces of type-specific information Dsd change depending on the type of trigger condition that has occurred.

In a case where the above-described trigger condition (a) has occurred, for example, an error in the system of the sensor 15 is conceivable, and the stress information D1 including a detection result of a force sensor 151 is thus more important than the operation history information D3 including an execution history of an operation program. Therefore, as illustrated in FIG. 8, the writing section 32 writes the type-specific information Dsd1 and the type-specific information Dsd3 in this order in the second memory 35. According to such a writing order, even if a writing error occurs while the specific operation information Ds is being written in the second memory 35, there is an increased possibility that the type-specific information Dsd1 at a high level of importance is appropriately stored in the second memory 35.

Similarly, even in a case where the above-described trigger condition (b) has occurred, an error in the system of the sensor 15 is conceivable, and the speed information D2 including a detection result of an encoder E is thus more important than the operation history information D3 including the execution history of the operation program. Therefore, as illustrated in FIG. 9, the writing section 32 writes the type-specific information Dsd2 and the type-specific information Dsd3 in this order in the second memory 35. According to such a writing order, even if a writing error occurs while the specific operation information Ds is being written in the second memory 35, there is an increased possibility that the type-specific information Dsd2 at a high level of importance is appropriately stored in the second memory 35.

On the other hand, in a case where the above-described trigger conditions (c) and (d) have occurred, an error or the like of the operation program is conceivable, and the operation history information D3 including the execution history of the operation program is thus more important than the stress information D1 and the speed information D2 including detection results of the sensor 15. Therefore, as illustrated in FIG. 10, the writing section 32 writes the type-specific information Dsd3, the type-specific information Dsd1, and the type-specific information Dsd2 in this order or writes the type-specific information Dsd3, the type-specific information Dsd2, and the type-specific information Dsd1 in this order in the second memory 35, for example. According to such a writing order, even if a writing error occurs while the specific operation information Ds is being written in the second memory 35, there is an increased possibility that the type-specific information Dsd3 at a high level of importance is appropriately stored in the second memory 35.

The writing order of the type-specific information Dsd1, the type-specific information Dsd2, and the type-specific information Dsd3 has been described above. Next, a method of writing each piece of type-specific information Dsd1, Dsd2, and Dsd 3 will be described.

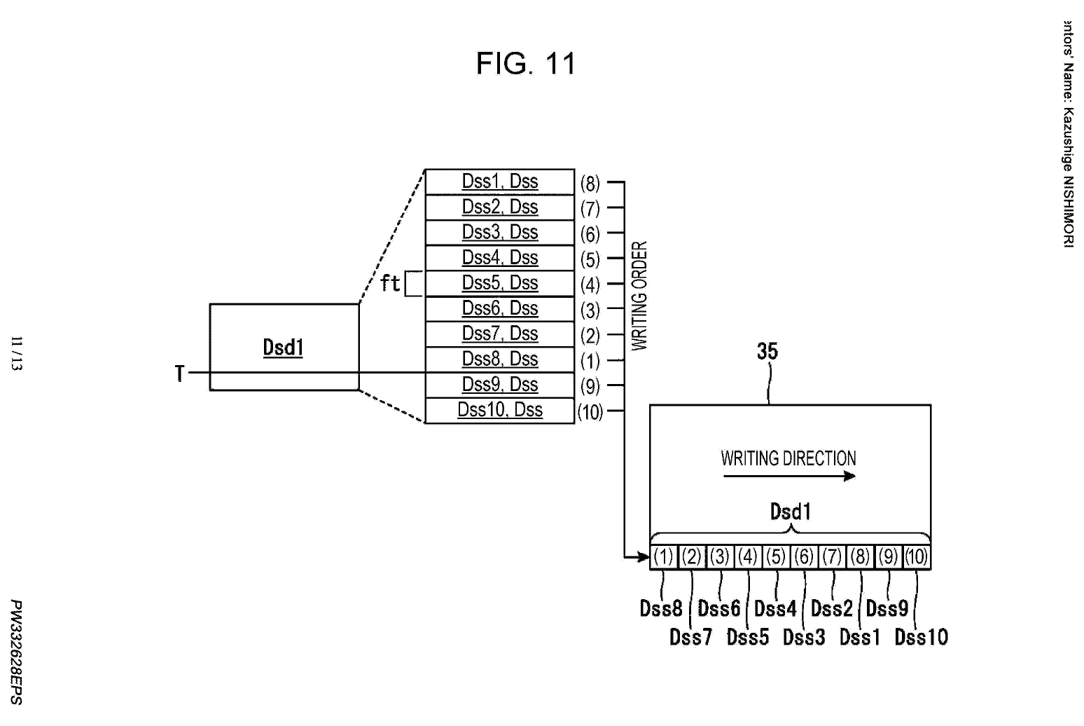

First, a method of writing the type-specific information Dsd1 including the stress information D1 will be described. As illustrated in FIG. 11, the writing section 32 divides the type-specific information Dsd1 into a plurality of pieces of time-specific information Dss for each predetermined unit time ft and sequentially writes the plurality of pieces of time-specific information Dss one by one in the second memory 35, similarly to the above-described first embodiment. Here, the type-specific information Dsd1 for 10 seconds (ΔTb = 8 seconds, ΔTa = 2 seconds) is divided into 10 pieces of time-specific information Dss1 to Dss10 for a predetermined period of time = 1 second similarly to the above-described first embodiment for convenience of description. In the type-specific information Dsd1, data before a clock time T at which the trigger condition has occurred, particularly data immediately before the clock time T is important. Therefore, it is preferable that the writing section 32 sequentially write data from the clock time T toward the past and then sequentially write data from the clock time T toward the future, for example, in the second memory 35. In other words, as illustrated in FIG. 11, it is preferable to write the time-specific information Dss8, the time-specific information Dss7, the time-specific information Dss6, the time-specific information Dss5, the time-specific information Dss4, the time-specific information Dss3, the time-specific information Dss2, the time-specific information Dss1, the time-specific information Dss9, and the time-specific information Dss10 one by one in this order in the second memory 35. According to such a writing order, even if a writing error occurs while the type-specific information Dsd1 is being written in the second memory 35, there is an increased possibility that at least the time-specific information Dss at a high level of importance is appropriately stored in the second memory 35.

A method of writing the type-specific information Dsd2 including the speed information D2 is similar to the above-described method of writing the type-specific information Dsd1. Therefore, description of the method of writing the type-specific information Dsd2 will be omitted.

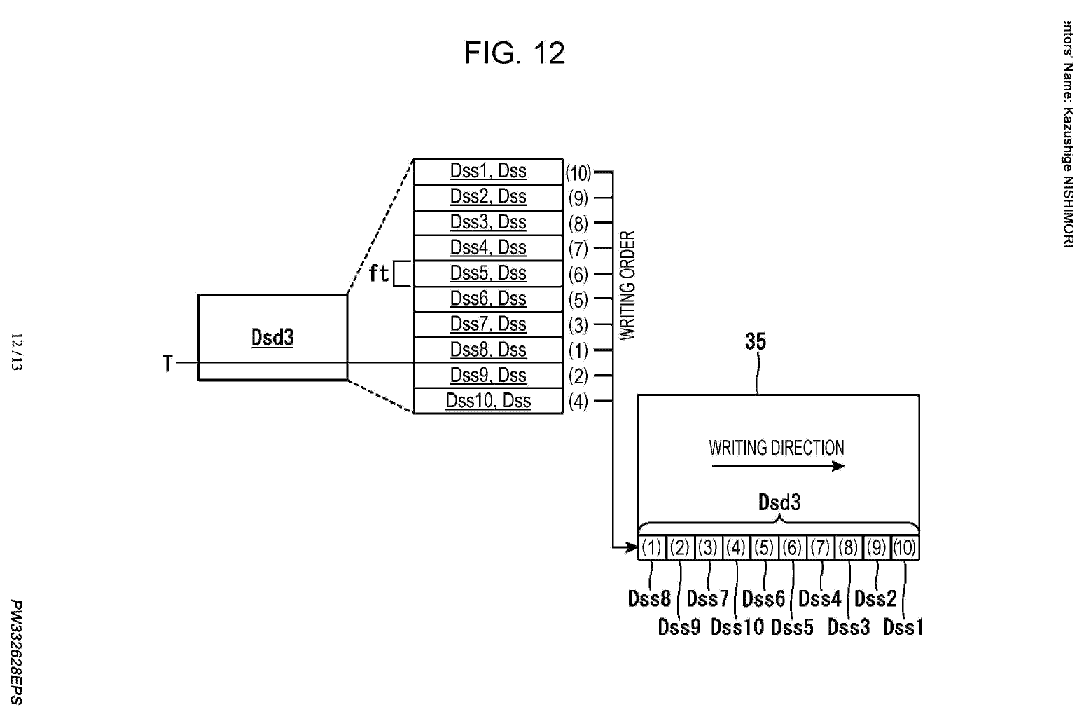

Next, a method of writing the type-specific information Dsd3 including the operation history information D3 will be described. As illustrated in FIG. 12, the writing section 32 divides the type-specific information Dsd3 into a plurality of pieces of time-specific information Dss for each predetermined unit time ft and sequentially writes the plurality of pieces of time-specific information Dss one by one in the second memory 35 similarly to the above-described first embodiment. Here, the type-specific information Dsd3 for 10 seconds (ΔTb = 8 seconds, ΔTa = 2 seconds) is divided into 10 pieces of time-specific information Dss1 to Dss10 for a predetermined period of time = 1 second similarly to the above-described first embodiment for convenience of description. In the type-specific information Dsd3, data at a clock time close to the clock time T at which the trigger condition has occurred is important. Therefore, it is preferable that the writing section 32 write data in the second memory 35 in ascending order of a time difference from the clock time T, for example. In other words, as illustrated in FIG. 12, it is preferable to write the time-specific information Dss8, the time-specific information Dss9, the time-specific information Dss7, the time-specific information Dss10, the time-specific information Dss6, the time-specific information Dss5, the time-specific information Dss4, the time-specific information Dss3, the time-specific information Dss2, and the time-specific information Dss1 one by one in this order in the second memory 35. In other words, it is preferable to write the type-specific information Dsd3 (time-specific information Dss8) for the predetermined unit time ft before the clock time T in the second memory 35 and then write the type-specific information Dsd3 (time-specific information Dss9) for the predetermined unit time ft after the clock time T in the second memory 35. According to such a writing order, even if a writing error occurs while the specific operation information Ds is being written in the second memory 35, there is an increased possibility that at least the time-specific information Dss at a high level of importance is appropriately stored in the second memory 35.

The specific operation information writing function has been described above. Next, an example of an information processing method of the present disclosure will be described using the flowchart illustrated in FIG. 13.

First, in Step S201, the information processing apparatus 3 stores the operation information D when the robot 1 is operating in the first memory 34 in real time. In other words, the operation information acquisition section 31 acquires the operation information D from the robot 1, and the writing section 32 writes the acquired operation information D in the first memory 34. Step S201 is an operation information storage step.

Next, in Step S202, the determination section 33 determines whether or not a trigger condition has occurred. Step S202 is a determination step.

In a case where the determination section 33 determines that "a trigger condition has occurred" in Step S202, the writing section 32 starts writing of the specific operation information Ds corresponding to the trigger condition that has occurred in the second memory 35 in Step S203. In the writing, the specific operation information Ds is divided into a plurality of pieces of type-specific information Dsd, and the plurality of pieces of type-specific information Dsd is written one by one in the second memory 35 in a preset order. Step S203 is a specific operation information writing step.

Next, in Step S204, the determination section 33 determines whether or not a new trigger condition has occurred.

In a case where the determination section 33 determines that "a trigger condition has occurred" in Step S204, the determination section 33 determines, in Step S205, whether or not the writing of the specific operation information Ds corresponding to a trigger condition that has occurred earlier in the second memory 35 has been finished.

In a case where the determination section 33 determines that "the writing has been finished" in Step S205, the writing section 32 starts writing of the specific operation information Ds corresponding to the trigger condition that has newly occurred in the second memory 35 in Step S206. Then, the processing returns to Step S204.

On the other hand, in a case where the determination section 33 determines that "the writing has not been finished" in Step S205, the determination section 33 determines, in Step S207, whether or not a level of importance of the trigger condition that has newly occurred is higher than a level of importance of the trigger condition that has occurred earlier.

In a case where the determination section 33 determines that "the level of importance is low" or "the level of importance is the same" in Step S207, the processing returns to Step S205. In other words, an end of the writing of the specific operation information Ds corresponding to the trigger condition that has occurred earlier in the second memory 35 is waited, the processing proceeds to Step S206 after the end, and the writing of the specific operation information Ds corresponding to the trigger condition that has newly occurred in the second memory 35 is started.

On the other hand, in a case where the determination section 33 determines that "the level of importance is high" in Step S207, the writing section 32 stops the writing of the specific operation information Ds corresponding to the trigger condition that has occurred earlier in the second memory 35 in the middle in Step S208, and the processing proceeds to Step S206 to start the writing of the specific operation information Ds corresponding to the trigger condition that has newly occurred in the second memory 35. Note that although not illustrated in the flowchart, in a case where the processing proceeds to Step S206 via Step S208, the writing of the remaining portion of the specific operation information Ds corresponding to the trigger condition that has occurred earlier in the second memory 35 may be restarted after the writing of the specific operation information Ds corresponding to the trigger condition that has newly occurred in the second memory 35 is finished.

According to such an information processing method, even if a writing error occurs while the specific operation information Ds is being written in the second memory 35, at least the type-specific information Dsd that has completely been written until then is appropriately stored in the second memory 35. In other words, even a portion of the specific operation information Ds can be stored in the second memory 35, and the concern that the entire specific operation information Ds may be lost decreases.

As described above, the information processing apparatus 3 of the present embodiment includes: the first memory 34 configured to store, for a certain period of time in real time, the operation information D when the robot 1 is operating; the determination section 33 configured to determine whether or not a predetermined trigger condition has occurred; and the writing section 32 configured to extract the specific operation information Ds corresponding to a reason for occurrence of the trigger condition from the operation information Ds stored in the first memory 34 and write the specific operation information Ds in the second memory 35 in the case where the determination section 33 determines that the "trigger condition has occurred". Also, the writing section 32 divides the specific operation information Ds into a plurality of pieces of type-specific information Dsd for each data type and writes the plurality of pieces of type-specific information Dsd one by one in the second memory 35. According to such a configuration, even if a writing error occurs while the specific operation information Ds is being written in the second memory 35, at least the type-specific information Dsd that has completely been written until then is appropriately stored in the second memory 35. In other words, there is an increased possibility that even a portion of the specific operation information Ds can be stored in the second memory 35, and the concern that the entire specific operation information Ds may be lost decreases.

As described above, the specific operation information Ds includes the stress information D1 and the speed information D2 which are the first type-specific information related to the first data type and the operation history information D3 which is the second type-specific information related to the second data type that is different from the first data type. Also, the writing section 32 determines, based on the type of the trigger condition that has occurred, which of the first type-specific information and the second type-specific information is to be written first in the second memory 35. The levels of importance of the first type-specific information and the second type-specific information change depending on the type of trigger condition. Therefore, it is possible to write information at a high level of importance in the second memory 35 first by determining, depending on the type of trigger condition, which of the first type-specific information and the second type-specific information is to be written first in the second memory 35. Therefore, even if a writing error occurs while the specific operation information Ds is being written in the second memory 35, there is an increased possibility that the information at a high level of importance is stored in the second memory 35.

As described above, the stress information D1 and the speed information D2, which are the first type-specific information, include detection results of the sensor 15 disposed in the robot 1. In addition, the writing section 32 writes the stress information D1 and the speed information D2 from the clock time T at which the trigger condition has occurred toward the past in the second memory 35. In a case where the detection results of the sensor 15 are analyzed, information before the clock time T, particularly, information closest to the clock time T is particularly effective. Therefore, it is possible to preferentially write more important information in the second memory 35 by adopting such a configuration. Therefore, even if a writing error occurs while the specific operation information Ds is being written in the second memory 35, there is an increased possibility that at least the information at a high level of importance is appropriately stored in the second memory 35.

As described above, the operation history information D3 which is the second type-specific information includes the execution history of the operation program which is a program for operating the robot 1. In addition, the writing SECTION 32 writes, in the second memory 35, the time-specific information Dss8 which is the type-specific information Dsd3 for the predetermined unit time ft before the clock time T at which the trigger condition has occurred and then writes, in the second memory 35, the time-specific information Dss9 which is the type-specific information Dsd3 for the predetermined unit time ft after the clock time T at which the trigger condition has occurred. In analysis of the specific operation information Ds, information before the clock time T is effective, and information for a period of time close to the clock time T is also effective. Therefore, it is possible to preferentially write the information in the closest period of time before and after the clock time T in the second memory 35 by adopting such a configuration. Therefore, even if a writing error occurs while the specific operation information Ds is being written in the second memory 35, there is an increased possibility that at least the information for the closest period of time before and after the clock time T at a high level of importance is stored in the second memory 35.

As described above, the information processing method by the information processing apparatus 3 includes: Step S201 as the operation information recording step of recording the operation information D when the robot 1 is operating in the first memory 34 in real time; Step S202 as the determination step of determining whether or not a predetermined trigger condition has occurred; and Step S203 as the specific operation information writing step of extracting the specific operation information Ds corresponding to the reason for occurrence of the trigger condition from the operation information D stored in the first memory 34 and writing the specific operation information Ds in the second memory 35 in the case where it is determined that "the trigger condition has occurred" in Step S202. In Step S203, the specific operation information Ds is divided into a plurality of pieces of type-specific information Dsd for each data type, and the plurality of pieces of type-specific information Dsd is written one by one in the second memory 35. According to such a method, even if a writing error occurs while the specific operation information Ds is being written in the second memory 35, at least the type-specific information Dsd that has completely been written until then is appropriately stored in the second memory 35. In other words, there is an increased possibility that even a portion of the specific operation information Ds can be stored in the second memory 35, and the concern that the entire specific operation information Ds may be lost decreases.

Such a second embodiment can also exhibit the same effects as in the above-described first embodiment.

Although the illustrated embodiments of the information processing apparatus and the information processing method of the present disclosure have been described, the present disclosure is not limited thereto. In addition, each section and each process of the information processing apparatus and the information processing method of the present disclosure can be replaced with an arbitrary structure and process which can exhibit a similar function. Furthermore, arbitrary structures or processes may be added.

1. An information processing apparatus comprising:
a first memory configured to store, for a certain period of time in real time, operation information when a robot is operating;
a determination section configured to determine whether or not a predetermined trigger condition has occurred; and
a writing section configured to extract specific operation information corresponding to a reason for occurrence of the trigger condition from the operation information stored in the first memory and write the specific operation information in a second memory in a case where the determination section determines that the trigger condition has occurred, wherein
the writing section divides the specific operation information into a plurality of pieces of time-specific information for each predetermined unit time and writes the plurality of pieces of time-specific information one by one in the second memory.

2. The information processing apparatus according to claim 1, wherein
the specific operation information includes first time-specific information that is the time-specific information before a clock time at which the trigger condition has occurred and second time-specific information that is the time-specific information after the clock time at which the trigger condition has occurred, and
the writing section writes the first time-specific information in the second memory and then writes the second time-specific information in the second memory.

3. The information processing apparatus according to claim 2, wherein
the specific operation information includes third time-specific information that is the time-specific information before the first time-specific information, and
the writing section writes the second time-specific information in the second memory and then writes the third time-specific information in the second memory.

4. An information processing apparatus comprising:
a first memory configured to store, for a certain period of time in real time, operation information when a robot is operating;
a determination section configured to determine whether or not a predetermined trigger condition has occurred; and
a writing section configured to extract specific operation information corresponding to a reason for occurrence of the trigger condition from the operation information stored in the first memory and write the specific operation information in a second memory in a case where the determination section determines that the trigger condition has occurred, wherein
the writing section divides the specific operation information into a plurality of pieces of type-specific information for each data type and writes the plurality of pieces of type-specific information one by one in the second memory.

5. The information processing apparatus according to claim 4, wherein
the specific operation information includes first type-specific information related to a first data type and second type-specific information related to a second data type that is different from the first data type, and
the writing section determines, based on a type of the trigger condition that has occurred, which of the first type-specific information and the second type-specific information is to be written first in the second memory.

6. The information processing apparatus according to claim 5, wherein
the first type-specific information includes a detection result of a sensor disposed in the robot, and
the writing section writes the first type-specific information from a clock time at which the trigger condition has occurred toward past in the second memory.

7. The information processing apparatus according to claim 6, wherein
the second type-specific information includes an execution history of a program for operating the robot, and
the writing section writes, in the second memory, the second type-specific information corresponding to a predetermined unit time before the clock time at which the trigger condition has occurred and then writes, in the second memory, the second type-specific information corresponding to the predetermined unit time after the clock time at which the trigger condition has occurred.

8. An information processing method comprising:
storing operation information when a robot is operating in a first memory in real time;
determining whether or not a predetermined trigger condition has occurred; and
extracting specific operation information corresponding to a reason for occurrence of the trigger condition from the operation information stored in the first memory and writing the specific operation information in a second memory in a case where the trigger condition is determined to have occurred in the determining, wherein
the specific operation information is divided into a plurality of pieces of time-specific information for each predetermined unit time, and the plurality of pieces of time-specific information is written one by one in the second memory in the writing of the specific operation information.

9. An information processing method comprising:
storing operation information when a robot is operating in a first memory in real time;
determining whether or not a predetermined trigger condition has occurred; and
extracting specific operation information corresponding to a reason for occurrence of the trigger condition from the operation information stored in the first memory and writing the specific operation information in a second memory in a case where the trigger condition is determined to have occurred in the determining, wherein
the specific operation information is divided into a plurality of pieces of type-specific information for each data type, and the plurality of pieces of type-specific information is written one by one in the second memory in the writing of the specific operation information.
